(19) United States
(12) Patent Application Publication
(10) Pub. No.: US 2023/0277919 A1
(43) Pub. Date: Sep. 7, 2023

(54) EDUCATIONAL BLOCKS

(71) Applicants: Aronny Valentino Noguera, Alexandria, VA (US); Natalia Jomaris Noguera, Alexandria, VA (US)

(72) Inventors: Aronny Valentino Noguera, Alexandria, VA (US); Natalia Jomaris Noguera, Alexandria, VA (US)

(21) Appl. No.: 17/685,856

(22) Filed: Mar. 3, 2022

(51) Int. Cl. A63F 3/04; A63F 9/04; G09B 19/22; G09B 1/16; G09B 1/34

(52) U.S. Cl. CPC A63F 3/04; A63F 9/04; G09B 19/22; G09B 1/16; G09B 1/34; A63F 9/0413; A63F 2009/0482; A63F 2009/0486

(57) ABSTRACT

An apparatus and method to stimulate creative thinking, initiate conversations, and improve social skills among participants in a game setting using educational blocks imprinted with a variety of indicia besides, letters, words and numbers including, but not limited to symbols, pictures of animals, flora/fauna, objects, tools, structures, sporting equipment, illustrations depicting diverse subject matter including, nature scenes, seasons, weather, human activities, and pictures depicting human emotions to attract emotional intelligence awareness. The educational blocks of the invention can be used to address different communication needs in various scenarios. The blocks can be used as an icebreaker activity in a classroom setting, an alternative approach to writer's block, conversation piece in social gatherings, family activities, used to exercise healthy-positive-advocating skills during contradictions, or to build a dialog for therapeutic purposes.

### CROSS REFERENCE TO RELATED APPLICATION

This application claims priority to Provisional Patent Application reference number: 63/254,071 filed, Oct. 9, 2021 which is incorporated herein, in its entirety.

### FIELD OF THE INVENTION

The present invention relates in general to educational products which also have an entertainment value. More particularly, the invention relates to a set of blocks, imprinted with a plurality of indicia including, but not limited to, letters, words, numbers, symbols and illustrations as a tool to stimulate creative thinking, initiate conversations and improve social skills.

### BACKGROUND OF THE INVENTION

The use of blocks and cubes imprinted with alphabets combined with a modicum of pictures as a means to educate children and in some cases adults, in forming words and sentences to improve their reading skills is, well known in the art. Some examples of these prior art include, U.S. Pat. Nos. 7,018,210, 3,728,800 and 2,987,833. The reading blocks described in these prior art do not provide a wider range of challenges such as initiating a conversation and improving social skills. There is a need in the art for educational blocks that provide a diverse set of indicia besides letters and words merely to form sentences, but rather to promote conversational and social skills in tandem with helping form grammatically correct sentences and building vocabulary. The present invention of educational blocks achieve these goals through a combination of simple to complex letters and words, symbols, numbers and illustrations depicting seasonal changes, human interactions, animals, flora and fauna, implements and tools used in everyday life and in the industry, to name a few examples.

The exemplary features and embodiments of the present invention will become obvious through the summary of the invention and the detailed description of the invention viewed in conjunction with the drawings.

### SUMMARY OF THE INVENTION

The present invention is a set of educational blocks that have an educational as well as an entertaining and gaming component. The product is comprised of between twenty six and fifty two blocks that are square-shaped, with the six faces of each block imprinted with a variety of indicia including, but not limited to letters, full and partial words, numbers, symbols, pictures of animals, flora/fauna, objects, tools, structures, sporting equipment, illustrations depicting diverse subject matter including, nature scenes, seasons, weather, human activities, and pictures depicting human emotions to attract emotional intelligence awareness, and stimulate talking points.

The primary object of the invention is to provide a tool to stimulate creative thinking, hone communication skills, and improve social interactions between individuals young and old from diverse backgrounds.

In the embodiments of the invention, the educational blocks of the invention are used in a game setting comprising 2-7 participants having at least a 9th grade level of education who have a rudimentary understanding of the English language, and are capable of forming at least one sentence, question, expression, or talking point to initiate a conversation with other participants.

In the exemplary embodiment of the invention, the participants in the game setting choose between one to x number of blocks depending on what the majority decide are the right number of blocks to use in a particular game using the blocks. The participants decide amongst themselves on who starts the game, and that decision may be based on the age of the participant chronologically from youngest to the eldest or eldest to the youngest. After each participant picks the agreed upon number of blocks, they take turns rolling/tossing the blocks on a flat surface. Once the blocks tossed land on the flat surface, the participant tossing their blocks during their turn arranges the blocks side-by-side in any order they see fit, using the letters, words, symbols, pictures, illustrations and other indicia appearing on the top face of the blocks to form a sentence, which may be in the form of a question, expression, or talking point and use their creative thinking to start a conversation with the other participants using the sentence, question or expression they formed from the indicia on their blocks. If the participant is unable to form even a single sentence, question or expression using the indicia on their selected blocks, they may ask permission to select an alternate set of blocks. In each round of the game the participants may pick one to x numbers of blocks depending on the rules they set at the outset of the game.

In the embodiments of the invention, the participants score points for forming creative sentences, questions and expressions through their blocks to initiate conversations. The participants can earn a full point, half point, or extra point depending on their creative sentences, questions, expressions, and/or talking points. A full point involves when the user uses all blocks selected to form or complete a full sentence, question, or expression. A participant may also earn a full point by adding a letter, or letters to a set of connected letters to create a word as for example adding an “l” to the connected letters “Oi” to create the word, “Oil.” The participant can then form a sentence with the word Oil as in, “I use olive oil for cooking.” A half point is deducted when the user takes away a block, or any letters, or parts of an indicia on the top view of their blocks yet is still able to form a sentence using their blocks. For example, taking away the letters “er” from the given word “Offer” to form the word “Off,” the user can create a sentence using this word as in, “I'm off to work.” Another example is that of taking away from an illustration on the block as in the illustration of “an owl on a tree branch.” In this example, a sentence can be formed about the “tree” and not the owl. For example: “We need more plants and trees to convert carbon dioxide to oxygen.” Earning an extra point involves forming a sentence by creatively interpreting and/or replacing a word or indicia by a synonym or closely related, category of words, characters, or other indicia, or illustrations inspired by the block's given choices. For example, If the top view of block selected shows the letters “Ov,” the user can add the letters “en”, to form the word “Oven” which can be modified by using the synonym “Stove” and form a sentence as in, “My grandmother prefers to use an electric stove.”

In an embodiment of the invention, the rules of the game may be customized such that the participants are allowed to use the indicia on all six sides of each block held by a participant to create their sentences, expressions, questions and talking points besides the indicia that show on the top face of the blocks after the blocks are tossed, providing the participant with a wider range of options to form creative sentences, questions, expressions and talking points. Thus the variety of indicia on all sides of a single block can provide the impetus to start a conversation on a subject of interest to the participant.

In the embodiments of the invention, a participant that forms sentences with the highest number of blocks holds the “lead/leader” title in the game. The participant that manages to use all 26 blocks to form multiple sentences, paragraphs or even going as far as creating a story using at least one of the indicia, combination of letters, words, or illustration of each block's top side view, is conferred with the ultimate title of having beaten the game.

In an embodiment of the invention, the educational blocks may be used by just one individual as in playing a game of solitaire.

The embodiments of the invention can be used to address different communication needs in various scenarios. For example, it can be used as an icebreaker activity in a classroom setting, an alternative approach to writer's block, conversation piece in social gatherings, family activities, used to exercise healthy-positive-advocating skills during contradictions, or to build a dialog for therapeutic purposes.

### BRIEF DESCRIPTION OF THE DRAWINGS

FIG. 1 is a perspective view of an educational block of the invention printed with letters, words, half words and other indicia relating to the alphabet A.

FIG. 2 is a perspective view of an educational block of the invention printed with letters, words, half words and other indicia relating to the alphabet B.

FIG. 3 is a perspective view of an educational block of the invention printed with letters, words, half words and other indicia relating to the alphabet C.

FIG. 4 is a perspective view of an educational block of the invention printed with letters, words, half words and other indicia relating to the alphabet D.

FIG. 5 is a perspective view of an educational block of the invention printed with letters, words, half words and other indicia relating to the alphabet E.

FIG. 6 is a perspective view of an educational block of the invention printed with letters, words, half words and other indicia relating to the alphabet F.

FIG. 7 is a perspective view of an educational block of the invention printed with letters, words, half words and other indicia relating to the alphabet G.

FIG. 8 is a perspective view of an educational block of the invention printed with letters, words, half words and other indicia relating to the alphabet H.

FIG. 9 is a perspective view of an educational block of the invention printed with letters, words, half words and other indicia relating to the alphabet I.

FIG. 10 is a perspective view of an educational block of the invention printed with letters, words, half words and other indicia relating to the alphabet J.

FIG. 11 is a perspective view of an educational block of the invention printed with letters, words, half words and other indicia relating to the alphabet K.

FIG. 12 is a perspective view of an educational block of the invention printed with letters, words, half words and other indicia relating to the alphabet L.

FIG. 13 is a perspective view of an educational block of the invention printed with letters, words, half words and other indicia relating to the alphabet M.

FIG. 14 is a perspective view of an educational block of the invention printed with letters, words, half words and other indicia relating to the alphabet N.

FIG. 15 is a perspective view of an educational block of the invention printed with letters, words, half words and other indicia relating to the alphabet O.

FIG. 16 is a perspective view of an educational block of the invention printed with letters, words, half words and other indicia relating to the alphabet P.

FIG. 17 is a perspective view of an educational block of the invention printed with letters, words, half words and other indicia relating to the alphabet Q.

FIG. 18 is a perspective view of an educational block of the invention printed with letters, words, half words and other indicia relating to the alphabet R.

FIG. 19 is a perspective view of an educational block of the invention printed with letters, words, half words and other indicia relating to the alphabet S.

FIG. 20 is a perspective view of an educational block of the invention printed with letters, words, half words and other indicia relating to the alphabet T.

FIG. 21 is a perspective view of an educational block of the invention printed with letters, words, half words and other indicia relating to the alphabet U.

FIG. 22 is a perspective view of an educational block of the invention printed with letters, words, half words and other indicia relating to the alphabet V.

FIG. 23 is a perspective view of an educational block of the invention printed with letters, words, half words and other indicia relating to the alphabet W.

FIG. 24 is a perspective view of an educational block of the invention printed with letters, words, half words and other indicia relating to the alphabet X.

FIG. 25 is a perspective view of an educational block of the invention printed with letters, words, half words and other indicia relating to the alphabet Y.

FIG. 26 is a perspective view of an educational block of the invention printed with letters, words, half words and other indicia relating to the alphabet Z.

### DETAILED DESCRIPTION OF THE INVENTION

The present invention of educational blocks overcome the deficiencies in the prior art educational blocks, by providing a means to improve social interactions between individuals from diverse backgrounds and age groups. The educational blocks of the invention achieve this goal by providing a wider range of indicia besides letters and words commonly found in the prior art blocks which are primarily used to improve reading skills. The wide range of indicia gathered from a variety of sources and imprinted on the educational blocks of the present invention provide the user with flexible options to form creative sentences, questions, expressions and talking points which the prior art educational blocks do not provide. The educational blocks of the present invention are aimed at stimulating the user's creative thinking and also encouraging them to share their general knowledge on a variety of topics, life experiences and interests with others, when participating in a group game setting using the blocks, resulting in healthy communications and social interactions with others in the group.

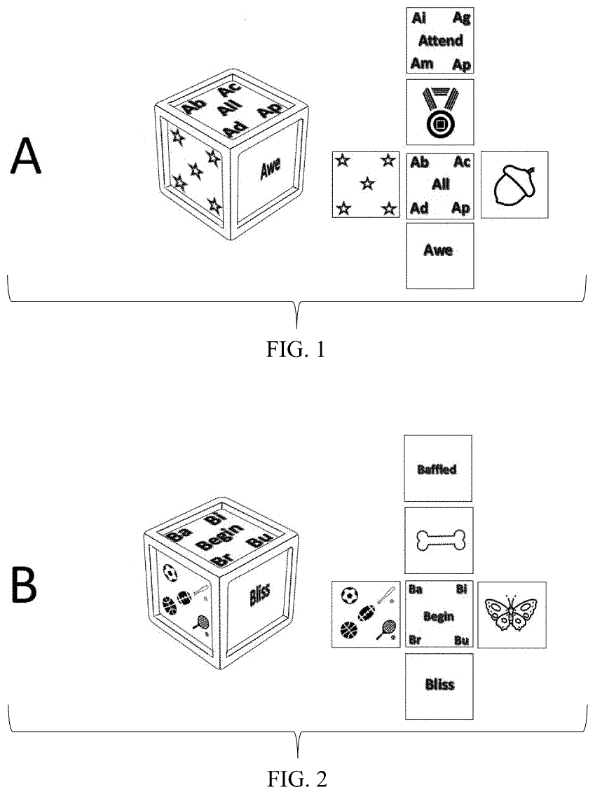

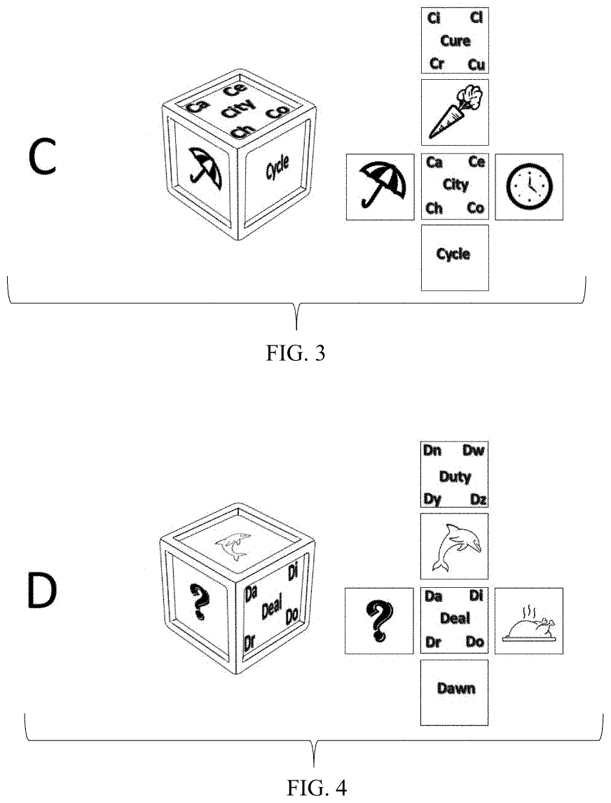

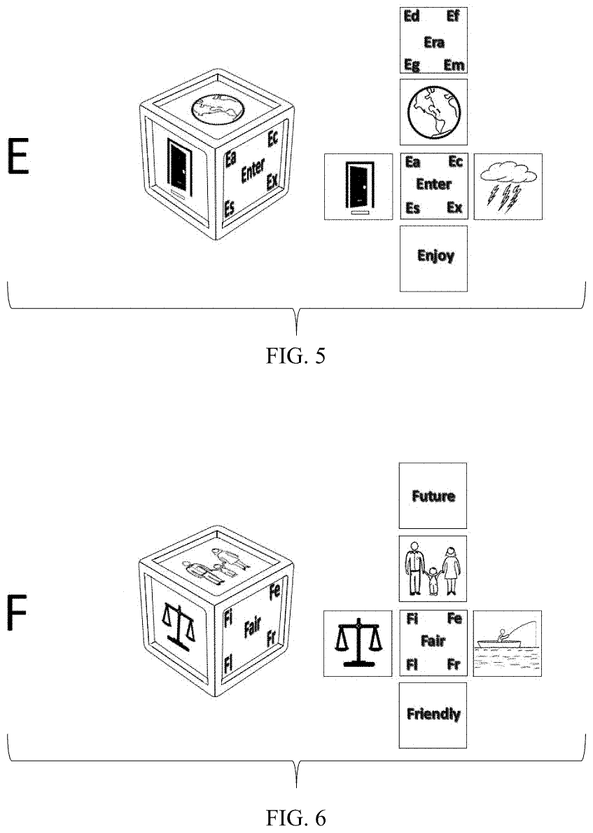

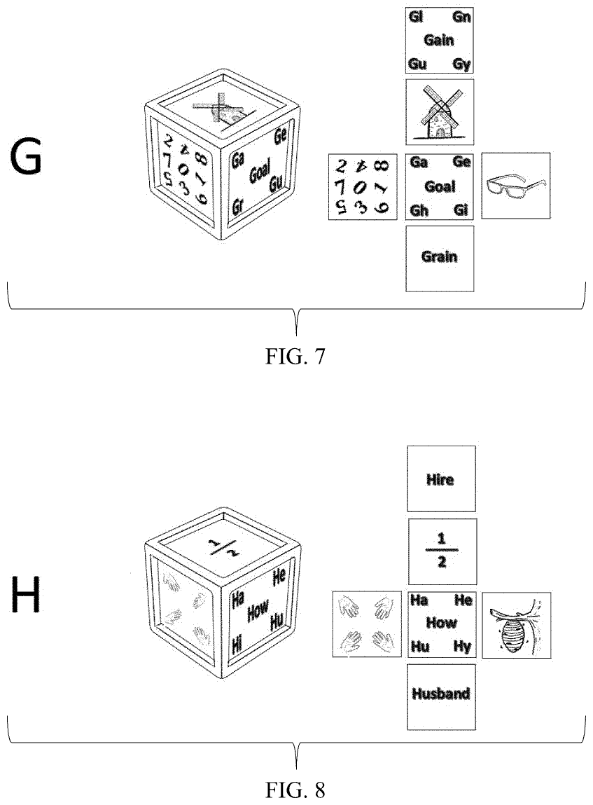

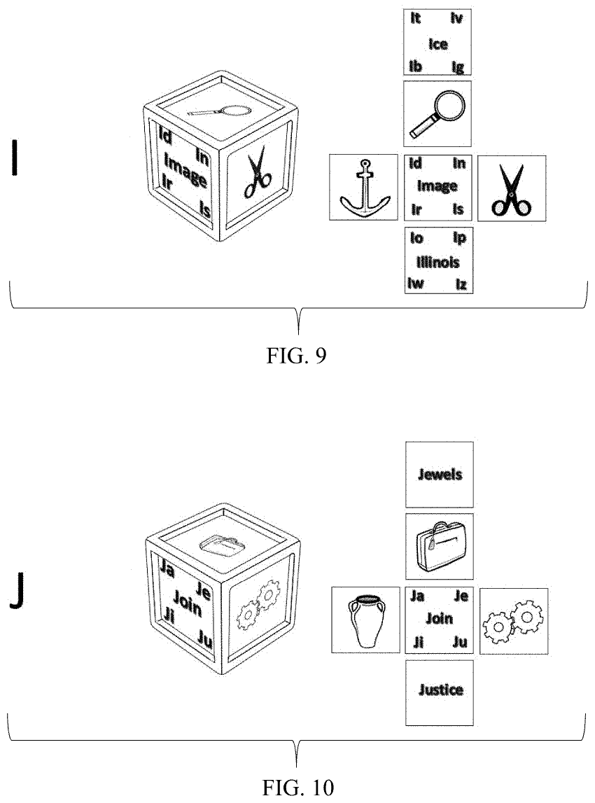

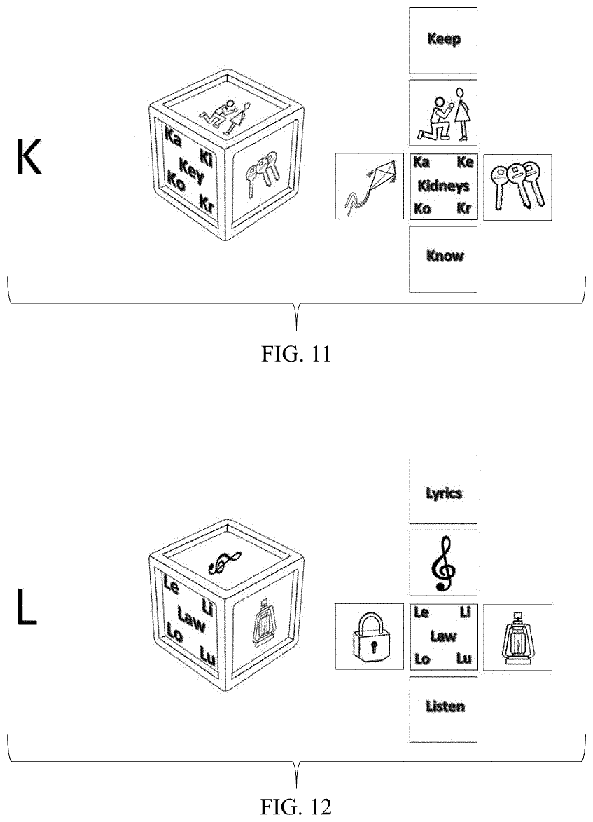

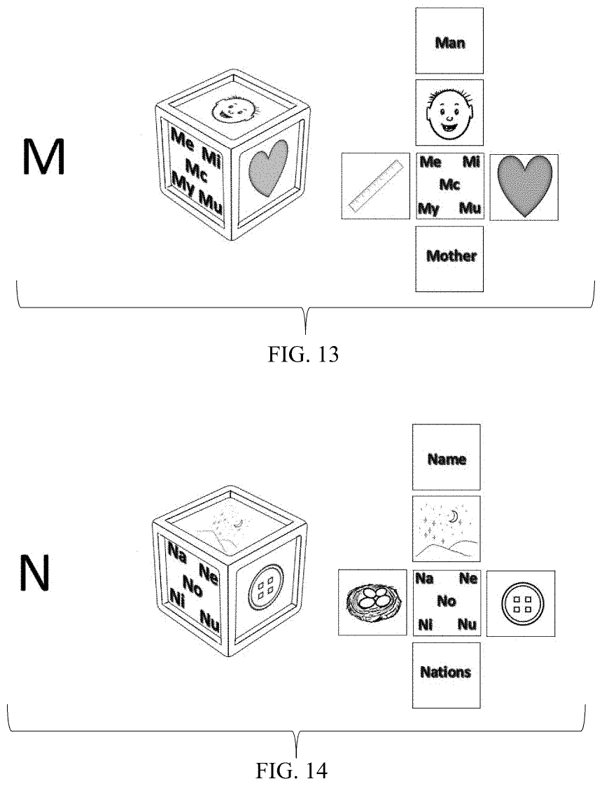

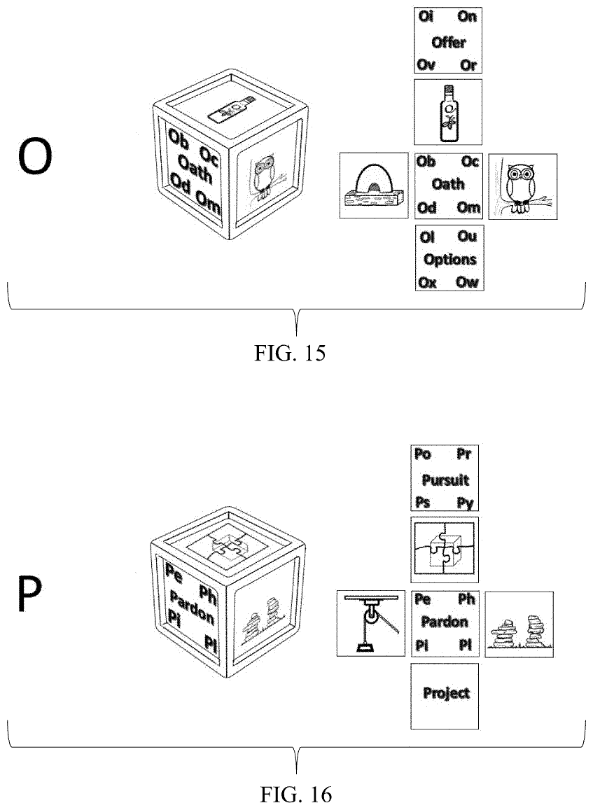

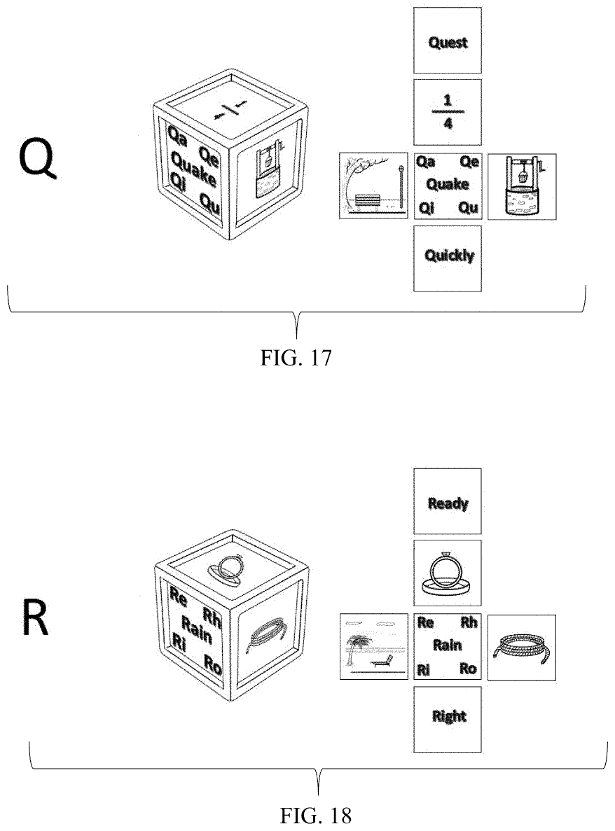

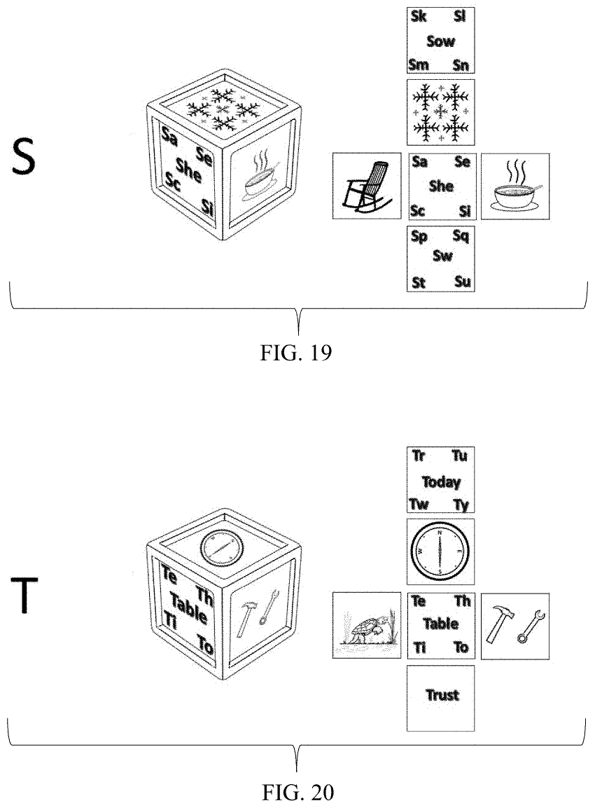

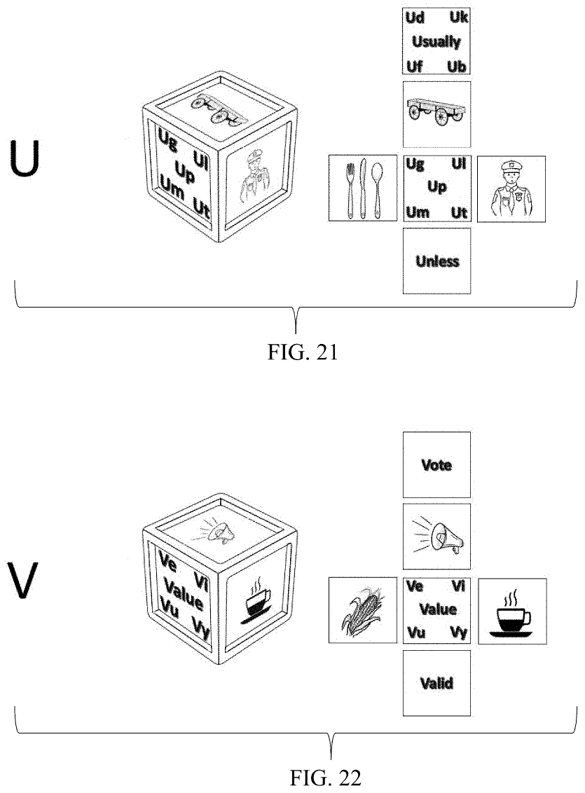

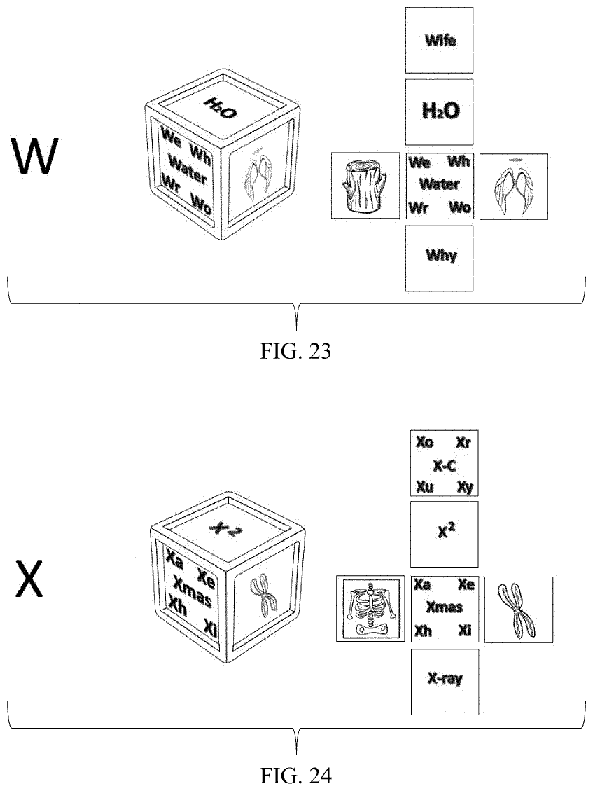

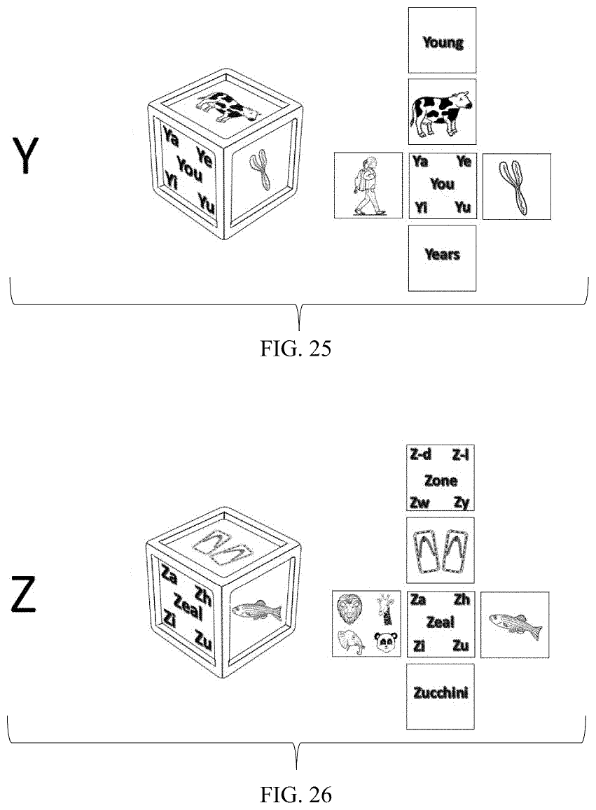

The exemplary embodiment of the invention is comprised of twenty six blocks representing the twenty six alphabets from A to Z in the English language. Referring now to the drawings, FIG. 1 to FIG. 26 are perspective views of the educational blocks of the invention, printed with letters, words, half words and other indicia with each figure relating to the alphabets A to Z. These educational blocks are combined to form a game set to be played by a plurality of participants interested in honing their communication and social skills. The participants in the game include anyone with at least a 9th grade education to senior citizens. The participants in the game choose between one to x number of blocks depending on what the majority decides are the right number of blocks to use in a particular game using the blocks. The participants after conferring with each other set the grounds rules for each game including who in the group tosses their blocks first, the youngest or oldest among them. The participants then pick an agreed upon number of blocks, randomly between, 1-7 from the total number of blocks depending on the number of players so that each player has the same number of blocks out of the total 26 blocks at the start of the game. After each participant picks the agreed upon number of blocks, they take turns rolling/tossing the blocks on a flat surface. Once the blocks are tossed land on the flat surface, the participant tossing their blocks during their turn arranges the blocks side-by-side in any order they see fit, using the letters, words, symbols, pictures, illustrations and other indicia appearing on the top face of the blocks to form a sentence, which may be in the form of a question, expression, or talking point and use their creative thinking to start a conversation with the other participants using the sentence, question or expression they formed from the indicia on their blocks. If the participant is unable to form even a single sentence, question or expression using the indicia on their selected blocks, they may ask permission to select an alternate set of blocks.

The educational block game of the present invention is played using a point system wherein each player is able to score points based on their creativity in coming up with appropriate and unusual sentences, questions and expressions using the indicia on the blocks they picked at the outset of the game. The participants can earn a full point, half point, or extra point depending on their creative sentences, questions, expressions, and/or talking points. A full point involves when the user uses all blocks to form or complete a full sentence, question, or expression. A participant may also earn a full point by adding a letter to a set of connected letters to create a word as for example adding an “l” to the connected letters “Oi” to create the word, “Oil.” The participant can then form a sentence with the word Oil as in, “I prefer to use olive oil when I'm cooking.” A half point is deducted when the user takes away any letters or indicia from the blocks, yet still forms a sentence. For example, taking away the letters “er” from the given word “Offer” to form the word “Off,” the user can create a sentence using this word as in, “I'm off to work.” Another example is that of taking away from an illustration on the block as in the illustration of “an owl on a tree branch.” In this example, a sentence can be formed about the “tree” and not the owl. For example: “We need more plants and trees to convert carbon dioxide to oxygen.” Earning an extra point involves forming a sentence by creatively interpreting and/or replacing a word or indicia by a synonym or closely related, category of words, characters, or other indicia, or illustrations inspired by the block's given choices. For example, If the top view of block selected shows the letters “Ov,” the user can add the letters “en”, to form the word “Oven” which can be modified by using the synonym “Stove” and form a sentence, “My grandmother prefers to use an electric stove.”

The educational blocks of the invention provides the means for participants to aspire to claim the title as the “lead/leader” who achieved the goal of using all twenty six blocks to form multiple creative sentences and even going as far as to write and narrate a story using the indicia on the blocks.

The rules of the game using the educational blocks of the invention may be customized to allow participants to use the indicia on all six sides of each block held by a participant to create their sentences, expressions, questions and talking points besides the indicia that show on the top face of the blocks after the blocks are tossed. This allows more flexibility and a wider range of options for each participant to form creative sentences, questions, expressions and talking points to claim the title of “lead/leader” in a game. Thus the variety of indicia on a single block can provide the stimulus for creative thinking and an impetus to start a conversation on a subject of interest to the participant.

The embodiments of the present invention as described herein do not limit any application or scope of the invention. It is to be understood that the invention can be carried out and practiced in various ways and implemented in embodiments other than the ones outlined in the description above. It should be understood and obvious to one skilled in the art that alternatives, modifications, and variations of the embodiments of the present invention may be construed as being within the spirit and scope of the appended claims.

I claim:

1. An apparatus for promoting creative thinking, initiating conversations and improving social skills, said apparatus comprising:
a plurality of twenty six square-shaped blocks having six faces;
said six faces of said plurality of square-shaped blocks imprinted with a plurality of indicia including, but not limited to, letters, full words, partial words, numbers, symbols, pictures of animals, flora/fauna, objects, tools, structures, sporting equipment, illustrations depicting diverse subject matter including, nature scenes, seasons, weather, human activities, pictures depicting human emotions;
said plurality of blocks used in a game setting as a means to educate a plurality of participants in said game setting to form creative sentences, questions, expressions and talking points using said plurality of indicia on said plurality of blocks; and
said plurality of participants forming said creative sentences, questions, expressions and talking points using said plurality of indicia on said plurality of blocks to initiate conversations and interact socially with said plurality of participants in said game setting.

2. The apparatus as in claim 1 wherein the participants in the game setting have a rudimentary understanding of the English language to form a sentence, a question, an expression, a talking point to initiate a conversation with other participants.

3. The apparatus as in claim 1 wherein the participants take turns to toss an assigned number of blocks on to a flat surface to start the game.

4. The apparatus as in claim 3 wherein the participants arrange the tossed blocks side by side to form a sentence, a question, an expression, a talking point using the indicia on the top face of the blocks.

5. The apparatus as in claim 4 wherein the participants arrange the tossed blocks side by side to form a sentence, a question, an expression, a talking point using the indicia on the top face of the blocks to initiate a conversation.

6. The apparatus as in claim 5 wherein the participants arrange the tossed blocks side by side to form a sentence, a question, an expression, a talking point using the indicia on the six faces of the blocks to initiate a conversation.

7. The apparatus as in claim 6 wherein the participants use the six faces of all twenty six blocks to form creative sentences, write a story using the indicia on the blocks.

8. The apparatus as in claim 7 wherein the participant who uses all twenty six blocks to form multiple creative sentences, write a story using the indicia on the block, claims the title of leader.

9. The apparatus as in claim 1 wherein the blocks are used as an icebreaker activity in a classroom setting, used to overcome writer's block, used as a conversation piece in social gatherings, family activities, used to build a dialog for therapeutic purposes.

10. A method for promoting creative thinking, initiating conversations and improving social skills, said method comprising:
(a) participants in a game setting selecting a set of educational blocks imprinted with a plurality of indicia including, but not limited to letters, full words, partial words, numbers, symbols, pictures of animals, flora/fauna, objects, tools, structures, sporting equipment, illustrations depicting diverse subject matter including, nature scenes, seasons, weather, human activities, pictures depicting human emotions;
(b) said participants in said game setting tossing said selected set of educational blocks on a flat surface and arranging said blocks side by side to form a sentence, a question, an expression, a talking point using said indicia on said tossed educational blocks;
(c) said participants using said, sentence, question, expression, talking point formed from said indicia on said educational blocks to initiate said conversations;
(d) said participants earning half points and full points, for forming creative sentences, questions, expressions, and talking points;
(e) said participants earning extra points for forming a sentence by replacing an indicia on said educational blocks by a synonym, closely related category of words, characters, illustrations to form a sentence, a question, an expression, a talking point;
(f) said participants earning extra points and lead title for forming multiple creative sentences, writing a story using all said educational blocks; and
(g) said plurality of indicia on said educational blocks stimulating creative thinking by said participants and to share their general knowledge on a variety of topics, life experiences and interests with other participants, resulting in healthy social interactions between participants.
